(19) United States
(12) Patent Application Publication
(10) Pub. No.: US 2007/0288994 A1
(43) Pub. Date: Dec. 13, 2007

(54) SYSTEM AND METHOD FOR PREVENTING ATTACK FOR WIRELESS LOCAL AREA NETWORK DEVICES

(75) Inventor: CHENG-WEN TANG, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/686,965

(22) Filed: Mar. 16, 2007

(30) Foreign Application Priority Data
Jun. 9, 2006 (TW) 95120560

(51) Int. Cl. H04L 9/32

(52) U.S. Cl. 726/2

(57) ABSTRACT

A method for preventing an attack for wireless local area network devices is applied in a wireless local area network. The wireless local area network includes a access point and a mobile station. The method includes generating fake media access control (MAC) addresses by the access point; transmitting the fake MAC address to the mobile station by the access point; identifying whether frames to be sent by the access point and the mobile stations are encrypted or not; if the frames are not encrypted; setting address fields of the unencrypted frames to the fake MAC addresses of the mobile station and the access point.

### BACKGROUND

1. Field of the Invention

The present invention generally relates to wireless local area network (WLAN), and more particularly to a system and a method for preventing an attack for wireless local area network devices.

2. Related Art

As specified in the Institute of Electrical and Electronics Engineers (denoted by IEEE) 802.11 wireless local area network (WLAN), frames such as management frames need to be encrypted before broadcasting. However, other frames such as media access control management protocol data unit (MMPDU) frames, power save poll (PS-Poll) frames, and quality of service-null (QoS-Null) frames are not encrypted before broadcasting according to the IEEE 802.11 WLAN protocol, and consequently, hackers can easily intercept these unencrypted frames and obtain media access control (MAC) addresses of network devices therefrom; thereby, network security is breached.

Therefore, a heretofore unaddressed need exists in the industry to overcome the aforementioned deficiencies and inadequacies.

### SUMMARY

A system for preventing an attack for wireless local area network devices is applied in a wireless local area network. The wireless local area network includes an access point and a mobile station. The system includes an address generation module, a transmission module, a first identification module, a first setting module, a second identification module, and a second setting module. The address generation module, the transmission module, the first identification module, and the first setting module are disposed in the access point. The second identification module, and the second setting module are disposed in the mobile station. The address generation module generates fake media access control (MAC) addresses. The transmission module transmits the fake MAC addresses generated by the address generation module. The first identification module identifies whether frames to be sent by the transmission module are encrypted or not. The first setting module sets address fields of unencrypted frames sent by the access point to the fake MAC addresses. The second identification module identifies whether frames to be sent by the mobile station are encrypted or not. The second setting module sets the address fields of unencrypted frames sent by the mobile station to the fake MAC addresses.

A method for preventing an attack for wireless local area network devices is applied in a wireless local area network. The wireless local area network includes an access point and a mobile station. The method includes generating fake media access control (MAC) addresses by the access point; transmitting the fake MAC addresses to the mobile station by the access point; identifying whether frames to be sent by the access point and the mobile station are encrypted or not; if the frames are unencrypted; setting address fields of the unencrypted frames to the fake MAC addresses of the mobile station and the access point.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram illustrating an application environment of a system for preventing an attack for wireless local area network devices in accordance with an exemplary embodiment of the invention, the system including an access point and mobile stations;

FIG. 2A is a block diagram of the access point of FIG. 1;

FIG. 2B is a block diagram of one of the mobile stations of FIG. 1;

FIG. 3A illustrates an unencrypted frame set by a first setting module in accordance with the exemplary embodiment of the invention;

FIG. 3B illustrates an unencrypted frame set by a second setting module in accordance with the exemplary embodiment of the invention;

FIG. 4 is a flowchart of a method for preventing an attack for wireless local area network devices in accordance with another exemplary embodiment of the present invention;

FIG. 5A illustrates a beacon frame sent by the access point of FIG. 2A in accordance with the exemplary embodiment of the method of FIG. 4; and

FIG. 5B illustrates an association request frame sent by the mobile station of FIG. 2B in accordance with the exemplary embodiment of the method of FIG. 4.

### DETAILED DESCRIPTION OF THE EMBODIMENTS

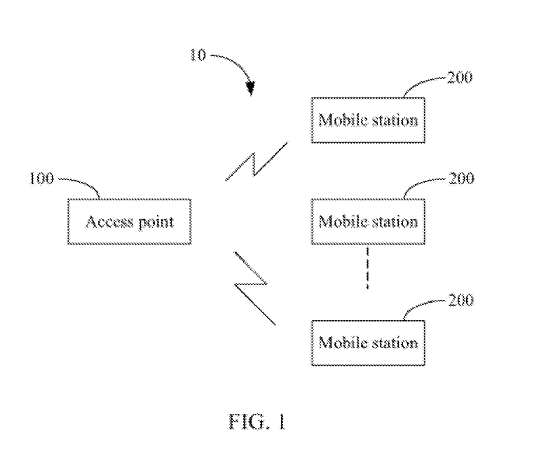

FIG. 1 is a schematic diagram illustrating an application environment of a system for preventing an attack for wireless local area network devices in accordance with an exemplary embodiment of the invention.

In this embodiment, the wireless local area network 10 includes an access point 100 and at least one mobile station 200. The access point 100 communicates with the mobile station 200 based on the Institute of Electrical and Electronics Engineers (IEEE) 802.11 wireless local area network (WLAN) protocol. In this embodiment, the mobile station 200 may be a notebook, a personal digital assistant (PDA), or so on.

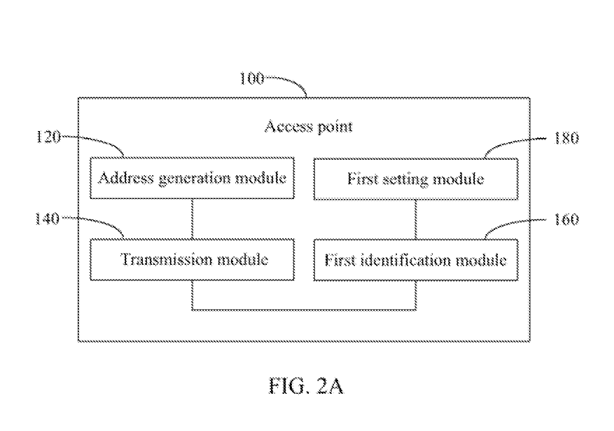

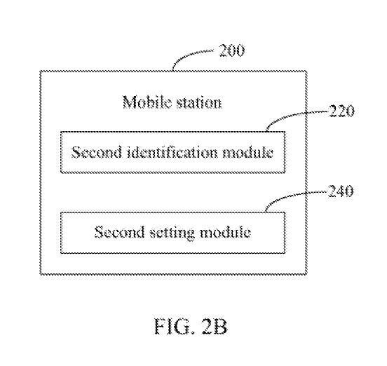

FIG. 2A is a block diagram of the access point 100 of FIG. 1. The access point 100 includes an address generation module 120, a transmission module 140, a first identification module 160, and a first setting module 180.

The address generation module 120 generates fake media access control (MAC) addresses for the access point 100 and the mobile station 200. In this embodiment, the fake MAC addresses generated by the address generation module 120 are different from MAC addresses of other access point 100s and other mobile station 200s. In another embodiment, the address generation module 120 can be instead installed in any of the mobile stations of FIG. 1.

The transmission module 140 transmits the fake MAC addresses generated by the address generation module 120 to the mobile station 200. In another embodiment, the transmission module 140 can be instead installed in any of the mobile stations of FIG. 1 and transmits the fake MAC addresses generated by the address generation module 120 to the access point 100 of FIG. 1.

The first identification module 160 identifies whether frames to be sent by the transmission module 140 of the access point 100 are encrypted or not. According to the IEEE 802.11 WLAN protocol, media access control management protocol data unit (MMPDU) frames and quality of service-null (QoS-Null) frames are not encrypted by the access point 100 prior to being sent. Therefore, the first identification module 160 identifies whether the frames to be sent by the access point 100 are unencrypted or not by identifying whether the frames are the MMPDU frames or the QoS-Null frames.

The first setting module 180 sets address fields of unencrypted frames to the fake MAC addresses generated by the address generation module 120. In this embodiment, the first setting module 180 sets a destination address subfield and a source address subfield of the unencrypted frames to a fake MAC address of the mobile station 200 and a fake MAC address of the access point 100, respectively.

FIG. 2B is a block diagram of the mobile station 200 of FIG. 1. The mobile station 200 includes a second identification module 220 and a second setting module 240.

The second identification module 220 identifies whether the frames to be sent by the mobile station 200 are encrypted or not.

In IEEE 802.11 protocol, power save poll (PS-Poll) frames, the MMPDU frames, and the QoS-Null frames are not encrypted by the mobile station 200 prior to being sent. Therefore, the second identification module 220 identifies whether the frames to be sent by the mobile station 200 are encrypted or not by identifying whether the frames are PS-Poll frames, MMPDU frames, or QoS-Null frames.

The second setting module 240 sets address fields of unencrypted frames.

In this embodiment, the second setting module 240 sets a destination address subfield and a source address subfield of the unencrypted frames to a fake MAC address of the access point 100 and a fake MAC address of the mobile station 200, respectively.

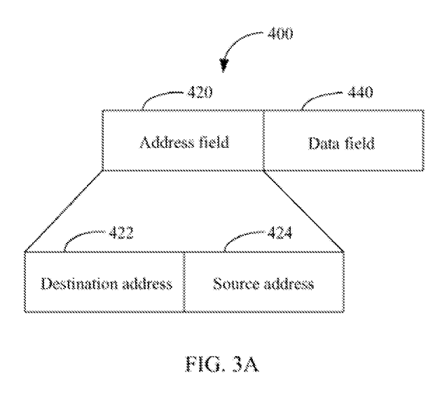

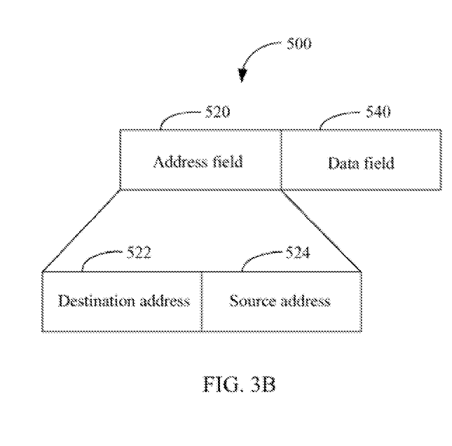

FIG. 3A illustrates an unencrypted frame 400 set by the first setting module 180 in accordance with the exemplary embodiment of the invention.

In this embodiment, the unencrypted frame 400 includes an address field 420 and a data field 440. The address field 420 further includes a destination address subfield 422 and a source address subfield 424. The first setting module 180 sets the destination address subfield 422 to a fake MAC address of the mobile station 200, and sets the source address subfield 424 to a fake MAC address of the access point 100.

FIG. 3B illustrates an unencrypted frame 500 set by the second setting module 240 in accordance with the exemplary embodiment of the invention.

In this embodiment, the unencrypted frame 500 includes an address field 520 and a data field 540. The address field 520 further includes a destination address subfield 522 and a source address subfield 524. The second setting module 240 sets the destination address subfield 522 to a fake MAC address of the access point 100, and sets the source address subfield 524 to a fake MAC address of the mobile station 200.

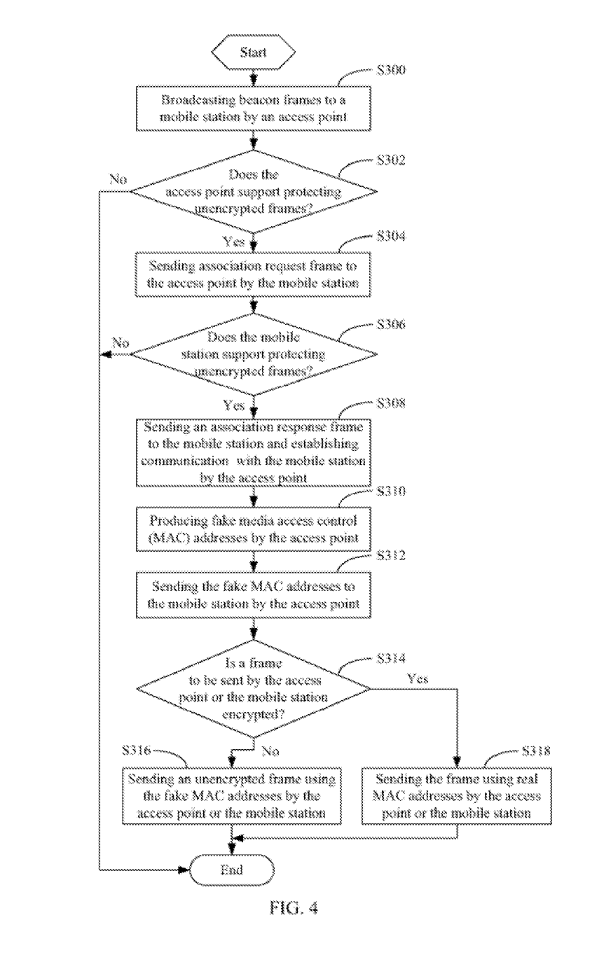

FIG. 4 is a flowchart of a method for preventing an attack in a wireless local area network 10 in accordance with another exemplary embodiment of the present invention.

In step S300, the access point 100 broadcasts beacon frames to the mobile station 200.

In this embodiment, the beacon frames include an information element that indicates whether the access point 100 supports protecting unencrypted frames. In detail, the access point 100 sets a content subfield of an undefined information element for indicating whether the access point 100 can protect unencrypted frames from an attack. When the content subfield of the information element is set to 1, the content subfield indicates that the access point 100 can protect unencrypted frames; when the content subfield of the information element set to 0, the content subfield indicates that the access point 100 cannot protect unencrypted frames.

In step S302, the mobile station 200 judges whether the access point 100 supports protecting unencrypted frames.

In this embodiment, after the mobile station 200 receives the beacon frames, the mobile station 200 judges whether the access point 100 supports protecting unencrypted frames by checking the value of the content subfield of the beacon frames. If the access point 100 doesn't support protecting unencrypted frames, the mobile station 200 ends the communication.

If the access point 100 supports protecting unencrypted frames, in step S304, the mobile station 200 sends association request frames to the access point 100.

In this embodiment, the association request frames include information that indicates whether the mobile station 200 supports protecting unencrypted frames. In detail, the mobile station 200 sets a content subfield of an undefined information element to indicate whether the mobile station 200 supports protecting unencrypted frames. When the content subfield of the information element is set to 1, the content subfield indicates that the mobile station 200 supports protecting unencrypted frames; when the content subfield of the information element is set to 0, the content subfield indicates that the mobile station 200 does not support protecting unencrypted frames.

In step S306, the access point 100 judges whether the mobile station 200 supports protecting unencrypted frames.

In this embodiment, after the access point 100 receives the association request frames, the access point 100 judges whether the mobile station 200 supports protecting unencrypted frames by checking the content subfield of the association request frames. If the mobile station 200 doesn't support protecting unencrypted frames, the access point 100 ends the communication.

If the mobile station 200 supports protecting unencrypted frames, in step S308, the access point 100 sends the association response frames to the mobile station 200 and establishes communication with the mobile station 200.

In step S310, the access point 100 produces fake MAC addresses.

In this embodiment, after the access point 100 is connected with the mobile station 200, the address generation module 120 generates fake MAC addresses for the access point 100 and the mobile station 200 respectively. For preventing the fake MAC addresses from conflicting with MAC addresses of other access point 100s and other mobile station 200s, the fake MAC addresses generated by the address generation module 120 are different from MAC addresses of other access point 100s and other mobile station 200s.

In step S312, the access point 100 sends the fake MAC addresses to the mobile station 200.

In this embodiment, the transmission module 140 transmits the fake MAC addresses of the access point 100 and the mobile station 200 to the mobile station 200 in encrypted data frames.

In step S314, the access point 100 and the mobile station 200 judges whether frames to be sent are encrypted. If the frames to be sent by the access point 100 or the mobile station 200 are encrypted, go to step 316. If the frames to be sent by the access point 100 or the mobile station 200 are unencrypted, go to step 318.

In this embodiment, the method for judging whether the frames to be sent by the access point 100 or the mobile station 200 are encrypted or not is as follows. In IEEE 802.11 WLAN protocol, the PS-Poll frames, the MMPDU frames, and the QoS-Null frames to be sent in the wireless area network are not encrypted. When the access point 100 is to send frames to the mobile station 200, the first identification module 160 identifies the frames to be sent by the access point 100 are MMPDU frames, or QoS-Null frames. When the mobile station 200 sends frames to the access point 100, the second identification module 220 identifies the frames to be sent to the access point 100 are PS-Poll frames, MMPDU frames, or QoS-Null frames.

In step S316, the access point 100 or the mobile station 200 sends unencrypted frames using the fake MAC addresses.

In this embodiment, when the access point 100 sends the unencrypted frames to the mobile station 200, the destination address subfield 422 and the source address subfield 424 are set to the fake MAC address of the mobile station 200 and the fake MAC address of the access point 100, respectively, by the first setting module 180, (the unencrypted frame is shown in FIG. 3A). When the mobile station 200 sends unencrypted frames to the access point 100, the destination address subfield 522 and the source address subfield 524 are set to fake MAC address of the access point 100 and the fake MAC address of the mobile station 200, respectively, by the second setting module 240, (the unencrypted frame is shown in FIG. 3B).

In step S318, sending the encrypted frames using the real MAC addresses by the access point 100 or the mobile station 200.

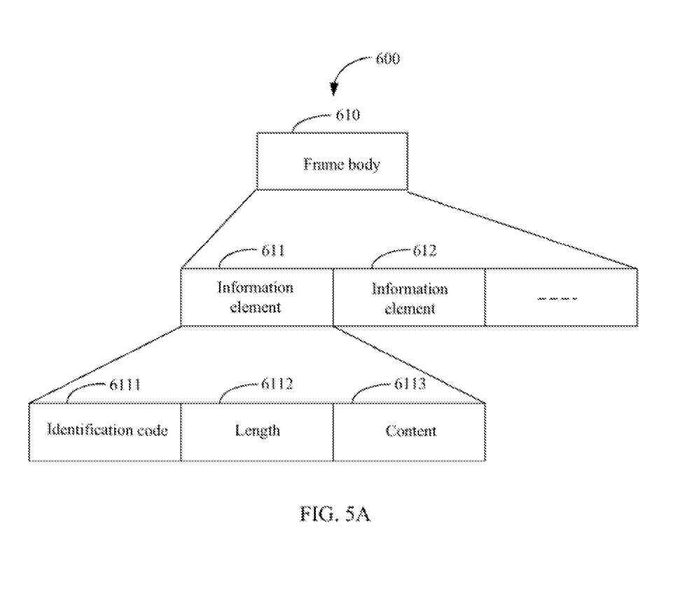

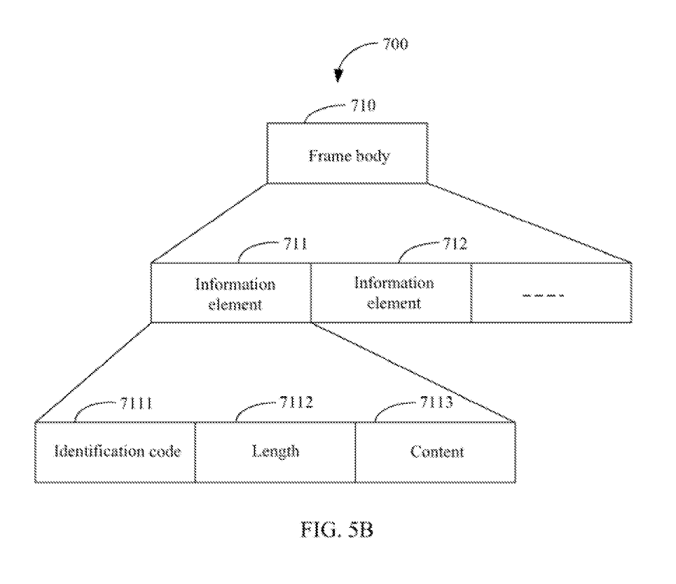

FIG. 5A illustrates a beacon frame 600 sent by the access point 100 in accordance with the exemplary embodiment of the invention.

In IEEE 802.11 protocol, the beacon frame 600 includes a frame body field 610. The frame body field 610 further includes information elements, such as information element subfield 611, information element subfield 612 and so on. Information element subfield 611 includes an identification code subfield 6111, a length subfield 6112, and a content subfield 6113. In IEEE 802.11 protocol, not all of the information elements are defined, some of the information elements are free. In this embodiment, using a free information element subfield 611. Setting the content subfield 6113 to 1 indicates the access point 100 supporting to protect unencrypted frames.

FIG. 5B illustrates an association request frame 700 sent by the mobile station 200 in accordance with the exemplary embodiment of the invention.

In IEEE 802.11 protocol, the association request frame 700 includes a frame body 710. The frame body 710 further includes many information elements, such as information element subfield 711, information element subfield 712, and so on. The frame body 711 includes an identification code subfield 7111, a length subfield 7112, and a content subfield 7113. In IEEE 802.11 protocol, not all of the information elements are defined; some of the information elements are available. In this embodiment, using a free information element subfield 711. Setting the content subfield 7113 to 1 indicates the mobile station 200 supports protecting unencrypted frames.

An embodiment of the wireless local area network and method for preventing the attack, address generation module 120 in the access point 100 generates fake MAC addresses for the access point 100 and the mobile station 200.

In other embodiments, after the access point 100 communicates with the mobile station 200, the fake MAC address of the access point 100 and the fake MAC address of the mobile station 200 could be generated by the mobile station 200.

What is claimed is:

1. A system for preventing an attack for wireless local area network devices, applied in a wireless local area network comprising an access point and a mobile station, the system comprising:
an address generation module, disposed in the access point, for generating fake media access control (MAC) addresses;
a transmission module, disposed in the access point, for transmitting the fake MAC addresses generated by the address generation module;
a first identification module, disposed in the access point, for identifying whether frames to be sent by the transmission module are encrypted or not;
a first setting module, disposed in the access point, for setting the address fields of unencrypted frames to be sent by the access point to the fake MAC addresses;
a second identification module, disposed in the mobile station, for identifying whether frames to be sent by the mobile station are encrypted or not; and
a second setting module, disposed in the mobile station, for setting the address fields of unencrypted frames to be sent by the mobile station to the fake MAC addresses.

2. The system for preventing an attack for wireless local area network devices as recited in claim 1, wherein the transmission module transmits the fake MAC addresses to the mobile station.

3. The system for preventing an attack for wireless local area network devices as recited in claim 1, wherein the address field comprises a destination address field and a source address field.

4. The system for preventing an attack for wireless local area network devices as recited in claim 3, wherein the first setting module sets the destination address field and the source address field of unencrypted frames to be sent by the access point to the fake MAC address of the mobile station and the fake MAC address of the access point, respectively.

5. The system for preventing an attack for wireless local area network devices as recited in claim 3, wherein the second setting module sets the destination address field and the source address field of unencrypted frames to be sent by the mobile station to the fake MAC address of the access point and the fake MAC address of the mobile station, respectively.

6. A method for preventing an attack for wireless local area network devices, applied in a wireless local area network comprising an access point and a mobile station, the method comprising:
generating a fake media access control (MAC) address by the access point;
transmitting the fake MAC address to the mobile station by the access point;
identifying whether the frames to be sent by the access point and the mobile station are encrypted or not; and
if the frames to be sent by the access point and the mobile station are unencrypted, setting address fields of the unencrypted frames to the fake MAC addresses of the mobile station and the access point.

7. The method for preventing an attack for wireless local area network devices as recited in claim 6, wherein the access point sends the fake MAC address of the access point and the fake MAC address of the mobile station to the mobile station in encrypted data frames.

8. The method for preventing an attack for wireless local area network devices as recited in claim 6, wherein if the frames to be sent by the access point and the mobile station are encrypted then the access point and the mobile station sends the frames directly.

9. The method for preventing an attack for wireless local area network devices as recited in claim 6, wherein unencrypted frames comprise media access control management protocol data unit (MMPDU) frames, power save poll (PS-Poll) frames, and quality of service-null (QoS-Null) frames.

10. A method for preventing an attack for a wireless local area network, comprising:
associating an access point with a mobile station in a wireless local area network to establish communication between said access point and said mobile station;
generating a fake media access control (MAC) address by one of said access point and said mobile station;
acknowledging said fake MAC address by the other of said access point and said mobile station through said communication between said access point and said mobile station; and
transmitting communicable frames between said access point and said mobile station through said communication between said access point and said mobile station by means of using said fake MAC address when said frames are identified as being unencrypted.

11. The method as recited in claim 10, wherein said frames identified as being unencrypted comprise media access control management protocol data unit (MMPDU) frames, power save poll (PS-Poll) frames, and quality of service-null (QoS-Null) frames.

12. The method as recited in claim 10, wherein said fake MAC address is generated by said access point and is transmitted to said mobile station after said access point is associated with said mobile station.
